(19) United States
(12) Patent Application Publication
(10) Pub. No.: US 2006/0254988 A1
(43) Pub. Date: Nov. 16, 2006

(54) Methods and compositions for the treatment of water

(75) Inventor: Mark Frampton, Parker, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: ConFirm Monitoring Systems, Inc., Englewood, CO (US)

(21) Appl. No.: 11/126,425

(22) Filed: May 10, 2005

(51) Int. Cl. C02F 1/50

(52) U.S. Cl. 210/764

(57) ABSTRACT

The present disclosure provides methods of treating water sources, including, but not limited to, dental unit water sources, in order to reduce the titer of bacteria and other pathogens in those water sources and also to inhibit biofilm growth and maintenance in surfaces, such as dental unit water lines, that come into contact with those water sources. The disclosure also provides solid compositions comprising silver citrate which are suitable for use in the disclosed treatment methods, and further provides methods for preparing such solid compositions.

### FIELD OF THE INVENTION

This disclosure relates to methods and compositions for the treatment of water sources.

### BACKGROUND OF THE INVENTION

Biofilms occur naturally whenever a solid surface is exposed to continual moisture. Biofilm formation is especially prevalent in dental unit water lines (DUWL). Biofilm formation in DUWLs is promoted by periods of non-use (such as overnight or over the weekend) as water within DUWL can stagnate. Even when the DUWL is in use, water flow closest to the wall of the narrow tubing is minimal, which allows further stagnation at this location.

Biofilm formation starts when molecules precipitate from the water onto the interior wall of the DUWL and promote the adherence of planktonic microorganisms from the water. After adherence, the organisms enter a growth phase and produce a slime layer comprised of polysaccharides which protects them from chemical and physical disturbances. Within the biofilm, the microorganisms can signal one another, transfer nutrients, and exchange genetic material. Biofilms may enhance the survival of pathogens such as Legionella pneumophila and Pseudomonas aeruginosa in water distribution systems. In addition, fungi, protozoa, and nematodes may also inhabit DWUL biofilms.

During DUWL use, microorganisms in the biofilm can detach and be flushed into the oral cavity of the patient, thereby leading to patient infection even if the water that is initially introduced into the DUWL is sterile. Splatter and aerosols from dental procedures may possibly infect health care personnel. “Suck back” of micro-organisms from the oral cavity occurs during handpiece and air-water syringe use and adds to the microbial population of the biofilm. Micro-organisms that are present in the incoming water supply may also colonize an established biofilm.

The American Dental Association has established a goal for dental water to contain no more than 200 Colony Forming Units (CFU)/mL. The U.S. Environmental Protection Agency (EPA) has established a limit of <500 CFU/mL of heterotrophic bacteria in drinking water. Thus, the number of bacteria in water used as a coolant/irrigant for dental procedures should be as low as reasonably achievable and, at a minimum, <500 CFU/mL.

### SUMMARY OF THE INVENTION

In one aspect, the disclosure provides methods for the treatment of water sources that are suspected of harboring bacteria and other pathogens, or that may become contaminated with bacteria and other pathogens. The methods involve adding a composition comprising silver citrate to the water source. The compositions comprising silver citrate optionally further comprise at least one surfactant. The treatment methods also inhibit biofilm growth and maintenance on surfaces that come into contact with the treated water.

In one embodiment, the disclosed treatment methods are used for the treatment of dental unit water sources and dental unit water lines in order to inhibit biofilm growth and maintenance within the dental unit water lines. Specifically, a composition comprising silver citrate, and optionally at least one surfactant, is added to the dental unit water source and then water from the dental unit water source is introduced into the dental unit water lines.

In another aspect, the disclosure provides solid compositions comprising silver citrate at greater than about 4,000 parts per million. The solid compositions may be used in the aforementioned methods of treating water sources, including the aforementioned methods of treating dental unit water sources and dental unit water lines.

In a further aspect, the disclosure provides solid compositions comprising silver dihydrogen citrate (Ag₃C₆H₅O₇). The compositions may be used in the aforementioned methods of treating water sources, including the aforementioned methods of treating dental unit water sources and dental unit water lines.

### BRIEF DESCRIPTION OF THE DRAWING

FIG. 1 illustrates a typical dental unit comprising a dental unit water reservoir 1 and dental unit water lines 2, 3, 4 that connect the dental unit water reservoir to dental handpieces such as a dental drill 5 and a dental irrigator 6. Treatment compositions comprising silver citrate may be added directly to the dental unit water reservoir.

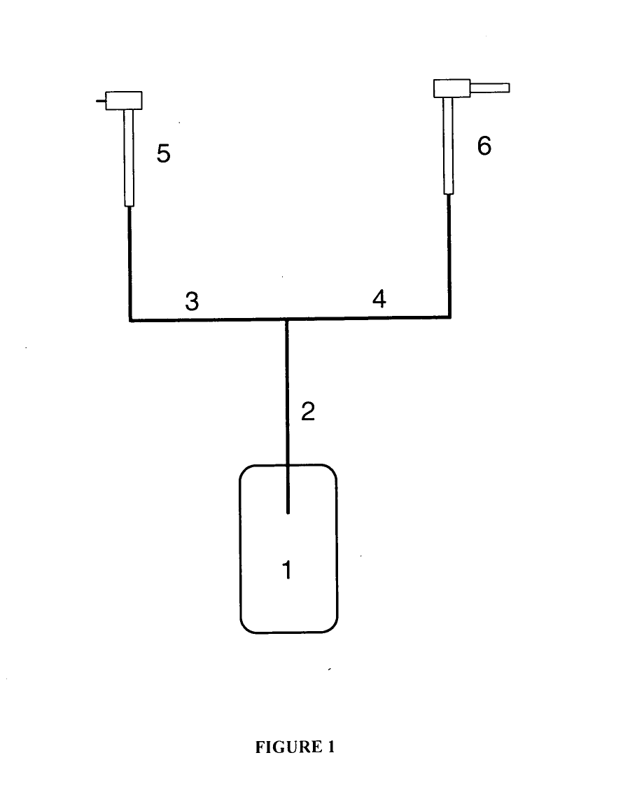

### DETAILED DESCRIPTION OF THE PREFERRED EMBODIMENTS

In the description that follows (including the section entitled “EXAMPLES”) all specified quantities and process conditions (including time, temperature, and the like) are examples only and are understood to include a range of equivalents. All such numerical examples are understood to be modified by the term “about,” whether or not this is explicitly stated, and the scope of the term “about” is a range of values as could be determined by one of ordinary skill in the art without undue experimentation.

Methods of Treating Water Using Silver Citrate

In one aspect, the disclosure provides methods of treating dental unit water sources and dental unit water lines (DUWL). The methods involve adding a treatment composition comprising silver citrate, and optionally at least one surfactant, to a dental unit water source. As water treated in this manner flows through the dental unit water lines, it inhibits the growth and maintenance of biofilm on the interior surface of the dental unit water lines, dental handpieces, and (if the dental unit is so equipped) the dental unit water reservoir. The treated water also reduces the titer of bacteria and other pathogens that are sloughed off from such biofilms and carried to the patient's mouth by water flow through the water lines. Water treated in this manner reduces the titer of bacteria and other pathogens that enter the dental water unit lines by “suck back” from the patient's mouth. Hence, the methods described herein reduce the titer of bacteria and other pathogens, and also inhibit the growth and maintenance of biofilm throughout the entire dental unit water system (including throughout the waste water handling system which may comprise vacuum lines and a cuspidor, each connected to a vacuum trap) during routine use in dental procedures.

In some embodiments, the dental unit water source may be an independent dental unit water reservoir (for example, a 700 mL or 2,000 mL water bottle) in which case the treatment composition can be introduced to the reservoir, either manually or using an automatic metering system, each time the reservoir is refilled. The reservoir may be refilled, for example, with tap water or with distilled water.

In other embodiments, the dental unit water source may be the municipal water supply or it may be water from a pretreatment system. In this case, the treatment composition may be added continually using an automatic metering system that is operatively connected to the supply pipe that brings the water to the dental unit. For example, the treatment composition can be held in a treatment reservoir that is connected to the supply pipe by a lateral line. A valve between the lateral line and the supply pipe can then control introduction of the treatment composition from the treatment reservoir via the lateral line into the supply pipe. An automated valve controller can control the rate at which the treatment composition is introduced into the supply pipe.

In another embodiment, the water source is water from a pretreatment system, and the treatment compositions are added directly to water within the pretreatment system.

By way of example, a treatment composition comprising silver citrate and sodium lauryl sulfate (SLS) may be introduced into a dental unit water source to yield a final concentration of between about 1 ppm to about 3 ppm of silver citrate and greater than about 0.003125% SLS in the water source. By way of another example, a treatment composition comprising silver citrate and a quaternary ammonium surfactant such as BTC2125M may be introduced in a dental unit water source to yield a final concentration of between about 1 ppm to about 3 ppm of silver citrate and about 6 ppm BTC 2125M in the water source. Either of these non-limiting examples of “maintenance” treatments can reduce an initial count of 5,000 Colony Forming Units (CFU)/mL of Pseudomonas aeruginosa in the water source to significantly less than 500 CFU/mL within 10 minutes at ambient temperature.

Water treated in this manner continues to reduce the titer of bacteria and other pathogens and inhibit biofilm growth and maintenance for an extended period of time, which prevents bacteria and other pathogens from recolonizing dental water unit lines that remain unused (and hence static with respect to water flow) for an extended period of time. Because the concentration of silver ion in the water that is treated in this manner is very low, only a negligible amount of silver ion is ingested by a dental patient if the patient swallows the treated water during a dental procedure. Such “maintenance” treatment can be continued by simply adding an appropriate amount of a composition comprising silver citrate and, optionally at least one surfactant, to the water reservoir each time the reservoir is refilled with water.

In another embodiment, dental unit water lines that already have an established biofilm growing therein are “shocked” by adding a composition comprising silver citrate, and optionally at least one surfactant, to the dental unit water source that will flow through the dental unit water lines. Such “shock” treatments can be used, for example, before beginning a “maintenance” treatment regime for the first time, and may be repeated periodically, for example every two weeks. The final concentrations of silver citrate in such “shock” treatments are preferably higher than in the aforementioned “maintenance” treatment. For example, the final silver citrate concentration in “shock” treated water can be between about 12 ppm to about 30 ppm. Following “shock” treatment for a period of time sufficient to reduce and remove the biofilm, the lines may be flushed with water, or with “maintenance” treatment water. In one embodiment, “shock” treatment may be carried out over the weekend, and prior to the first dental procedure after the weekend, the lines are flushed.

Dyes may be used in the aforementioned methods in order to indicate the treatment status of the water source. For example, solid or liquid treatment compositions used for the “shock” treatment may include a red dye, and formulations used for “maintenance” treatments may use a blue dye. In this way, the dental operator can know whether the dental unit is undergoing “shock” treatment, and hence should be flushed prior to use in dental procedures, or if it is undergoing “maintenance” treatment, and hence is suitable for use in dental procedures.

The methods disclosed herein are not restricted for use in dental units, but are generally applicable for the treatment of any other water source that is suspected of comprising bacteria and other pathogens, or that may become contaminated with bacteria and other pathogens. Thus, in another aspect the disclosure provides methods of treating water such as tap water, river water, well water, groundwater, water in cooling systems (including water in airconditioning systems, evaporative cooling systems, and humidifiers), water in hot tubs, and water stored in containers and other storage vessels (such as bottles), and other potentially contaminated sources of water by introducing a treatment composition comprising silver citrate, and optionally at least one surfactant, into the water source. Similarly, treatment compositions comprising silver citrate and optionally at least one surfactant may be added to water to inhibit the growth and maintenance of biofilm not only in dental water unit lines, but also in other water conduits, water containers, and other surfaces that come into contact with water, such as the interior surfaces of hot tubs. For example, compositions comprising silver citrate and optionally at least one surfactant may be added to water contained within the reservoirs of personal hydration systems, in order to inhibit the growth and maintenance of biofilm on the surfaces of such reservoirs and within drinking tubes attached to such reservoirs. Personal hydration systems are disclosed in U.S. Pat. Nos. 6,820,780; 6,675,998; 6,497,348; 6,364,168; and 6,070,767.

Preferably, treatment compositions comprising silver citrate, and optionally at least one surfactant, are used in solid form in the aforementioned methods of treating water (including dental water sources and other water sources) and inhibiting growth and maintenance of biofilm. For the treatment of a dental water source contained within a dental unit water reservoir, it is preferred that such solid compositions are added directly to dental unit water reservoir. More preferably, the treatment composition is in the form of a tablet, but powdered treatment compositions are also contemplated. Most preferably, the treatment compositions employed are in accordance with the section below entitled “Solid Formulations of Silver Citrate.” It is also contemplated that treatment compositions in liquid form may also be used. For example, it is expressly contemplated that AXENOHL® (which comprises about 2,400 ppm of electrolytically generated silver citrate in solution; see below in the section entitled “Solid Formulations of Silver Citrate”) or diluted solutions thereof may be added to the water source (which may be dental water source or other water source) to be treated, optionally along with at least one surfactant.

Surfactants suitable for use in the methods of the disclosure include nonionic surfactants, cationic surfactants, anionic surfactants, amphoteric surfactants and zwitterionic surfactants. Suitable surfactants include, but are not limited to, polyoxyethylene-polyoxypropylene co-polymers and block co-polymers known, for example, under the trade names PLURONIC or POLOXAMER (e.g. as described in Fiedler, H. P. “Lexikon der Hilfsstoffe fur Pharmazie, Kosmetik und angrenzende Gebiete”, Editio Cantor, D-7960 Aulendorf, 3rd revised and expanded edition (1989), the contents of which are hereby incorporated by reference); ethoxylated cholesterins known, for example, under the trade name SOLULAN, for example SOLULAN C24 commercially available from the Amerchol company; vitamin derivatives, e.g. vitamin E derivatives such as tocopherol polyethylene glycol succinate (TPGS) available from the Eastman company; sodium dodecylsulfate (SDS) or sodium laurylsulfate (SLS); bile acid or salts thereof, for example cholic acid, glycolic acid or a salt, e.g. sodium cholate; lecithin; glycenol monostearate; capric triglyceride; lauric triglyceride; glyceryl monoundecylenate; tetraglyceryl pentastearate and like; glycerides of medium-chain fatty acids; polysorbates; polyoxyethylene hydrogenated castor oil; polyoxyethylene castor oil; polyoxyethylene lanolin; polyoxyethylene lanolin alcohol; polyoxyethylene lauryl ether; polyoxyethylene cetyl ether; and quaternary ammonium surfactants including benzethonium chlorides (such as LONZAGARD manufactured by Lonza) and benzalkonium chlorides (such as BTC 2125M which is a mixture of n-alkyl dimethyl benzyl ammonium chlorides and n-alkyl dimethyl ethylbenzyl ammonium chlorides).

It is expressly contemplated that in embodiments where at least one surfactant is added to the water source, that the surfactant may be a part of the composition comprising the silver citrate, or that the surfactant may be added separately. If the surfactant is added separately, it may be in the same form as the composition comprising the silver citrate (i.e. solid or liquid form) or it may be in a different form.

Solid Formulations of Silver Citrate

In another aspect, the disclosure provides solid compositions comprising greater than about 4,000 ppm silver citrate, and optionally further comprising at least one surfactant. The inventors have discovered that such solid compositions may be obtained by at least partially dehydrating aqueous solutions of silver citrate comprising from between about 500 parts per million to about 10,000 parts per million of electrolytically generated silver citrate (0.1% silver citrate by volume corresponds to 1,000 ppm). Aqueous solutions comprising silver citrate in this concentration range may be produced using the method described in U.S. Pat. No. 6,197,814, and U.S. Pat. App. Pub. Nos. 2003/0178374, 2003/0198689, and 2002/0123523, each of which is specifically incorporated herein by reference in its entirety. The aforementioned patent and patent application publications describe methods by which silver citrate is formed by electrolytically generating silver ions in a solution of citric acid and water using silver electrodes. Using these methods, it is possible to generate aqueous solutions having concentrations of silver citrate that far exceed the concentrations achieved by dissolving non-electrolytically generated silver citrate (Ag₃C₆H₅O₇) in water. For example, whereas non-electrolytically generated silver citrate has a solubility maximum of 280 parts per million (ppm) (Merck Index, 11th edition, page 1348 (1989)), silver citrate solutions that are generated electrolytically may have silver citrate concentrations of up to about 10,000 ppm.

It is believed that the form of silver citrate in these electrolytically generated solutions is different from non-electrolytically generated silver citrate which contains three silver ions per citrate (Ag₃C₆H₅O₇). Specifically, it is believed that electrolytically generated silver citrate may have the formula AgC₆H₅O₇ (silver dihydrogen citrate). In more detail, the cation Ag+ may complexed with the citric acid. The citric acid anion is the counterion for this complex ion (Ag(CA)+X(Cit)-), wherein CA is (C₆H₈O₇—H₂O), wherein (Cit)- is (C₆H₇O₇)—, and where X is an integer. Another possibility is a zwitterion, where the negative charge is on the complex itself, (Ag+CA-) where the total charge of the complex is neutral. Either or both of these species may exist in the electrolytically-generated silver citrate. Multiple complexation to Ag+ is also possible.

Electrolytically-generated aqueous solutions of silver citrate made according to the methods in the aforementioned patents and patent application publications is sold under the trade name AXENOHL® by Innovative Medical Services. AXENOHL® comprises 2,400 ppm of electrolytically generated silver citrate.

Electrolytically-generated aqueous solutions of silver citrate may be at least partially dehydrated using, for example, spray drying techniques, evaporative techniques, or lyophilization techniques such as freeze-drying.

The solid compositions comprising silver citrate disclosed herein may optionally further comprise one or more surfactants, including, for example, nonionic surfactants, cationic surfactants, anionic surfactants, amphoteric surfactants and zwitterionic surfactants. Suitable surfactants include, but are not limited to, polyoxyethylene-polyoxypropylene co-polymers and block co-polymers known, for example, under the trade names PLURONIC or POLOXAMER (e.g. as described in Fiedler, H. P. “Lexikon der Hilfsstoffe fur Pharmazie, Kosmetik und angrenzende Gebiete”, Editio Cantor, D-7960 Aulendorf, 3rd revised and expanded edition (1989), the contents of which are hereby incorporated by reference); ethoxylated cholesterins known, for example, under the trade name SOLULAN, for example SOLULAN C24 commercially available from the Amerchol company; vitamin derivatives, e.g. vitamin E derivatives such as tocopherol polyethylene glycol succinate (TPGS) available from the Eastman company; sodium dodecylsulfate (SDS) or sodium laurylsulfate (SLS); bile acid or salts thereof, for example cholic acid, glycolic acid or a salt, e.g. sodium cholate; lecithin; glycenol monostearate; capric triglyceride; lauric triglyceride; glyceryl monoundecylenate; tetraglyceryl pentastearate and like; glycerides of medium-chain fatty acids; polysorbates; polyoxyethylene hydrogenated castor oil; polyoxyethylene castor oil; polyoxyethylene lanolin; polyoxyethylene lanolin alcohol; polyoxyethylene lauryl ether; polyoxyethylene cetyl ether; and quaternary ammonium surfactants including benzethonium chlorides (such as LONZAGARD manufactured by Lonza) and benzalkonium chlorides (such as BTC 2125M which is a mixture of n-alkyl dimethyl benzyl ammonium chlorides and n-alkyl dimethyl ethylbenzyl ammonium chlorides). Solid compositions comprising silver citrate and further comprising surfactants may be obtained by adding surfactants either to the aqueous solution of silver citrate prior to at least partially dehydrating the aqueous solution, or by adding the surfactants to the solid formulation of silver citrate itself.

The solid compositions disclosed herein comprising silver citrate, and optionally at least one surfactant, may be used for treating water in accordance with the methods provided in this disclosure in the section entitled “Methods of Treating Water Using Silver Citrate.”

The solid compositions provided herein may be processed further in order to provide them in a form that is amenable for treating water. For example, the solid compositions may be milled or ground to form a powder of uniform particle size, and the powder may be packaged in a suitable container. In another embodiment, one or more additives is added to the aqueous solution of silver citrate (prior to at least partially dehydrating the aqueous solution) or is added to the solid composition comprising silver citrate. The additives may be used to improve the physical properties of the solid formulations, for example, by improving the flowability of powders obtained by milling the solid formulation. The additives may also be used to facilitate the formation of tablets by any technique known in the art, such as by direct compression, by wet granulation, or by dry granulation. Tablets comprising silver citrate, and optionally at least one surfactant, are expressly contemplated herein and are especially useful for the treatment of dental unit water lines in dental units that have a water reservoir. Suitable additives include excipients (e.g., sucrose, starch, mannitol, sorbitol, lactose, glucose, cellulose, talc, calcium phosphate or calcium carbonate), binders (e.g., cellulose, methylcellulose, hydroxymethylcellulose, polypropylpyrrolidone, polyvinylpyrrolidone, gelatin, gum arabic, polyethyleneglycol, sucrose or starch), disintegrators (e.g., starch, carboxymethylcellulose, hydroxypropylstarch, low substituted hydroxypropylcellulose, sodium bicarbonate, calcium phosphate, or calcium citrate), lubricants (e.g., magnesium stearate, light anhydrous silicic acid, talc or sodium lauryl sulfate), flavoring agents (e.g., citric acid, menthol, glycine or orange powder), preservatives (e.g., sodium benzoate, sodium bisulfite, methylparaben or propylparaben), stabilizers (e.g., citric acid, sodium citrate or acetic acid), suspending agents (e.g., methylcellulose, polyvinylpyrrolidone, or aluminum stearate), dispersing agents (e.g., hydroxypropylmethylcellulose), and emulsifying agents. Dyes may also be added to the tablet form to serve as a positive indicator of the presence of silver citrate in treated water, or to provide tablets having a desired color. For dental applications, the aforementioned additives are chosen so that they do not interfere with enamel or with restorative dental materials (such as dentin bonding agents) and procedures.

Irrespective of the final form of the solid composition comprising silver citrate, it is preferred that the solid formulation will dissolve in water within less than 10 minutes, more preferably in less than 5 minutes, even more preferably in less than 2 minutes, and most preferably in less than 1 minute at ambient temperature with or without agitation of the water.

It is to be understood that the concentrations of silver citrate and (if present) surfactant in the methods and compositions disclosed herein, and in the examples below, are not limiting. Higher or lower concentrations may be used, and the determination of the efficacy of such higher or lower component concentrations in reducing the levels of bacterial and other pathogens is mere routine experimentation for one skilled in the art using the assay methods provided in the examples below, or using other assay methods known to those skilled in the art.

### EXAMPLES

The following examples are provided for illustrative purposes only and are not intended to limit the scope of the invention.

### Example 1

### Formation of Solid Formulations of Silver Citrate Having Silver Citrate Concentration of Approximately 11,000 ppm

Four liters of a silver citrate solution (2,374 ppm prepared according to the method described in U.S. Pat. No. 6,197,814) was spray dried with an inlet temperature of 300° F., an outlet temperature of 350° F., and a flow rate of 50 mLs/min to yield a solid formulation. The resulting solid formulation has a concentration of silver citrate of approximately 10,400 ppm. The solid formulation was then mixed with mixed with Citric Acid, Sodium Bicarbonate, FD&C Blue #1 Lake, and Polyvinylpyrrolidone, and pressed into tablets having a weight of about 142 mg. The resulting tablets have the following composition (% W/W):

| | |
|---|---|
| Silver citrate | 49.0% |
| Citric Acid | 21.2% |
| Na Bicarbonate | 27.8% |
| FD&C Blue #1 Lake | 0.061% |
| Polyvinylpyrrolidone | 1.96% |

### Example 2

### Ability of Tablets with Varying Amounts of Surfactant to Reduce P. aeruginosa Titre

Tablets produced according to the method of Example 1 were dissolved in three volumes of 700 mL sterile deionized water (SDIW) to yield three 700 mL solutions each with a silver citrate concentration of 1 ppm. Sodium lauryl sulfate (SLS) was then added to one solution for a concentration of 0.025% and to one solution to yield a concentration of 0.050%. One mL of a P. aeruginosa culture (1.04×10⁷ CFU/mL) was then added to the each of the three solutions. The solutions were swirled to mix the bacteria and then incubated for 10 minutes at ambient temperature. After 10 minutes, 10.0 mL was removed from each solution and transferred to 90 mL neutralizing recovery media (Nutrient Broth+0.05% Sodium Thioglycollate+0.07% Lecithin+0.5% Tween 80) in French square bottles and mixed. Serial ten fold dilutions were made as 1.0 mL in 9 mL phosphate buffered saline (PBS). One mL portions of each dilution (and of the contents of each French square bottle) were transferred to sterile petri plates and mixed with molten nutrient agar. The contents of the French square bottles were then filtered through a sterile 0.45 μm membrane filter. The plates were incubated for 24-48 hours at 35±2° C. Colonies were counted and multiplied by appropriate dilution factors to determine the number of surviving CFU per 700 mL test solution. The results were compared with 700 mL sterile distilled water (no tablet added) and with 700 mL of sterile distilled water treated with one A-Dec ICX® tablet (a dental water unit treatment tablet consisting of silver nitrate, sodium percarbonate, dimethyl benzyl ammonium chloride, and dimethyl ethylbenzyl ammonium chloride; final dissolved concentration is 0.05 ppm silver), both inoculated and processed as described above. The results are presented in Table 1 below:

TABLE 1

| Test Solution | Original CFU/mL | Final CFU/mL | % reduction |
|---|---|---|---|
| Silver citrate | 14857 | 2043 | 86% |
| Silver citrate + | 14857 | 0.3 | 99.998% |
| 0.025% SLS | | | |
| Silver citrate + | 14857 | 0 | 100% |
| 0.05% SLS | | | |
| A-dec ICX | 14857 | 0.4 | 99.997% |
| Sterile water | 14857 | 10100 | 32% |

The results illustrate that the tablets of Example 1 can reduce bacterial load by almost 100% in 10 minutes in the presence of 0.025% SLS, and by 100% in 10 minutes in the presence of 0.05% SLS. This reduction is equal or better to the performance of A-dec ICX tablets.

### Example 3

### Ability of Silver Citrate With Different Surfactants to Kill P. aeruginosa

Tablets according to Example 1 were dissolved in 700 mL of sterile deionized water to yield 1 ppm silver citrate in solution. Benzethonium chloride (LONZAGARD manufactured by Lonza) or benzalkonium chloride (BTC 2125M which is a mixture of n-alkyl dimethyl benzyl ammonium chlorides and n-alkyl dimethyl ethylbenzyl ammonium chlorides) were then added to the silver citrate solutions to measure the ability of the combination to kill P. aeruginosa within a 10-minute exposure period. For the benzethonium chloride test, either 0.42 mL or 0.63 mL of a 1% Lonzagard solution was added to the 700 mL solution to yield 6 ppm or 9 ppm respectively of Lonzagard. For the BTC2125M test, either 0.42 mL or 0.82 mL of a 1% Barquat MS100 solution was added to the 700 mL solution to yield 3 ppm or 6 ppm respectively of BTC2125M.

One mL of a ˜3.5×10⁶ CFU/ml culture of P. aeruginosa was added to each test solution so that there was a final concentration of ˜5000 CFU/ml in the 700 mL of test solution. The bottles were swirled to mix the bacteria into the solution and held for 10 minutes at ambient temperature. After 10 minutes, 10.0 ml were removed and transferred to 90 ml neutralizing recovery media in a French square bottle and mixed. Serial ten-fold dilutions were made as 1.0 ml into 9 ml PBS. One (1.0) ml portions of each dilution including the French square bottle were transferred to sterile petri plates and mixed with 25 ml molten nutrient agar (NA) (held at 45-50° C.). The contents of the French square bottle were then filtered through a sterile 0.45 μm membrane filter. The filter was rinsed with about 50 ml SDIW and transferred to NA in a petri plate. All plates were incubated for 24-48 hours at 35±2° C. Colonies were counted and multiplied by appropriate dilution factors to determine the number of surviving CFU of P. aeruginosa per ml of test solution. The results are tabulated in Table 2.

TABLE 2

| Test Solution | Orig. CFU/ml | CFU/ml | % Reduction |
|---|---|---|---|
| 1 ppm silver citrate + | 5571 | 1600 | 71.3% |
| 6 ppm Lonzagard | | | |
| 1 ppm silver citrate + | 5571 | 1350 | 75.8% |
| 9 ppm Lonzagard | | | |
| 1 ppm silver citrate + | 5571 | 820 | 85.3% |
| 3 ppm BTC 2125M | | | |
| 1 ppm silver citrate + | 5571 | 0.1 | 99.998% |
| 6 ppm BTC 2125M | | | |
| 1 ppm silver citrate | 5571 | 4000 | 28.2% |
| Sterile Deionized Water | 5571 | 10400 | 0% |

The results illustrate that: one tablet (according to Example 1) dissolved in 700 mL of water with 6 ppm or 9 ppm Lonzagard reduced the number of P. aeruginosa from 5571 CFU/ml to 1600 and 1350 CFU/ml respectively within 10 minutes; that one tablet (according to Example 1) dissolved in 700 mL of water with 3 ppm BTC 2125M reduced the number of P. aeruginosa from 5571 CFU/ml to 820 CFU/ml within 10 minutes; that one tablet (according to Example 1) dissolved in 700 mL of water with 6 ppm BTC 2125M reduced P. aeruginosa to 0.1 CFU/ml within 10 minutes; and that one tablet (according to Example 1) dissolved in 700 mL of water without any added surfactant reduced P. aeruginosa to 4000 CFU/ml within 10 minutes. There were 10,400 CFU/ml of P. aeruginosa recovered from the SDIW.

### Example 4

### Ability of Solid Silver Citrate to Reduce P. aeruginosa for Extended Periods of Time

Silver citrate powder (prepared according to Example 1, but not in tablet form) was dissolved in SDIW to yield a stock solution having 2,374 ppm silver citrate. From the 2,374 ppm stock solution, a 20 ppm stock solution was then made. Then, 105 mL of the 20 ppm stock was added to 595 mL SDIW in a glass bottle to make a final 700 mL solution of 3 ppm silver citrate. In addition, 35 mL of the 20 ppm stock was dissolved in 665 mL SDIW in a glass bottle to make a 700 mL solution of 1 ppm silver citrate. A third test solution was prepared comprising 700 mL SDIW into which one A-Dec ICX® tablet (see Example 2) was dissolved. A control solution comprising only 700 mL SDIW was also prepared.

On the first day of the study, 1 mL of a ˜3.5×10⁶ CFU/ml culture of P. aeruginosa was added to each test solution so that there was a final concentration of ˜5000 CFU/ml in each 700 mL solution. The bottles were swirled to mix the bacteria into the solution and held for 10 minutes at ambient temperature. After 10 minutes, 10.0 ml were removed and transferred to 90 ml neutralizing recovery media in a French square bottle and mixed. The 1 ppm solution was assayed again after 30 minutes of exposure. Serial ten-fold dilutions were made as 1.0 ml into 9 ml PBS. One (1.0) ml portions of each dilution including the French square bottle were transferred to sterile petri plates and mixed with 25 ml molten nutrient agar (NA) (held at 45-50° C.). The contents of the French square bottle were then filtered through a sterile 0.45 μm membrane filter. The filter was rinsed with about 50 ml SDIW and transferred to NA in a petri plate. All plates were incubated for 24-48 hours at 35±2° C. Colonies were counted and multiplied by appropriate dilution factors to determine the number of surviving CFU of P. aeruginosa per ml of test solution.

After 24, 72, and 168 hours, 1.0 mL of the 3.5×10⁵ CFU/mL P. aeruginosa culture added to each bottle so that there was a final concentration of 500 CFU/mL in each 700 mL test solution. The bottles were swirled to mix and held at 10 minutes (also 30 minutes for the 1 ppm silver citrate test solution) at ambient temperature. The above procedure was repeated to measure the number of surviving CFU of P. aeruginosa per 700 mL of each test solution. The 1 ppm solution and the SDIW control were further studied at days 14, 21, and 28 using the same procedure. The results are tabulated in Table 3.

TABLE 3

| | Test Solution | Original | Final | |
|---|---|---|---|---|
| Time | (Exposure time) | CFU/mL | CFU/mL | % reduction |
| 0 | 3 ppm (10 mins) | 4229 | 1360 | 68% |
| | 1 ppm (10 mins) | 4229 | 2070 | 51% |
| | 1 ppm (30 mins) | 4229 | 100 | 98% |
| | A-dec ICX (10 mins) | 4229 | 0.6 | 99.99% |
| | SDIW (10 mins) | 4229 | 4900 | n/a |
| 24 hours | 3 ppm (10 mins) | 614 | 90 | 85% |
| | 1 ppm (10 mins) | 614 | 270 | 56% |
| | 1 ppm (30 mins) | 614 | 70 | 89% |
| | A-dec ICX (10 mins) | 614 | 25 | 96% |
| | SDIW (10 mins) | 614 | 700 | n/a |
| 72 hours | 3 ppm (10 mins) | 914 | 210 | 77% |
| | 1 ppm (10 mins) | 914 | 290 | 68% |
| | 1 ppm (30 minutes) | 914 | 120 | 87% |
| | A-dec ICX (10 mins) | 914 | 9.1 | 99% |
| | SDIW (10 mins) | 914 | 750 | 18% |
| 168 hours | 3 ppm (10 mins) | 500 | 300 | 40% |
| | 1 ppm (10 mins) | 500 | 350 | 30% |
| | 1 ppm (30 mins) | 500 | 90 | 82% |
| | A-dec ICX (10 mins) | 500 | 230 | 54% |
| | SDIW (10 mins) | 500 | 860 | n/a |
| 14 days | 1 ppm (30 mins) | 729 | 290 | 60% |
| | SDIW (10 mins) | 729 | 1471 | n/a |
| 21 days | 1 ppm (30 mins) | 1086 | 400 | 63% |
| | SDIW (10 mins) | 1086 | 770 | 29% |
| 28 days | 1 ppm (30 mins) | 800 | 50 | 94% |
| | SDIW (10 mins) | 800 | 1050 | n/a |

The results indicate that silver citrate at 1 ppm is able to reduce P. aeruginosa counts to less than 500 CFU/mL after 30 minutes of exposure. Reduction to less than 500 CFU/mL within 30 minutes is also observed when the same 1 ppm silver citrate solution is challenged with additional P. aeruginosa after 24 hours, 72 hours, 168 hours, 14 days, 21 days, and 28 days. Thus, 1 ppm silver citrate is capable of reducing bacterial titer to less than 500 CFU/mL for an extended period of time. This indicates that compositions comprising silver citrate that are dissolved in dental unit water sources to a final concentration of 1 ppm are able to maintain a low titer of bacteria throughout the entire dental unit (including the dental unit water lines) during prolonged periods of dental unit inactivity, such as occurs overnight and over the weekend.

### Example 5

### Ability of Silver Citrate Tablets and Varying Concentrations of Surfactant to Reduce Titre of P. aeruginosa

Silver citrate tablets (prepared according to Example 1) were dissolved in 700 mL volumes of SDIW in glass bottles to yield solutions having 1 ppm of silver citrate. To each 700 mL solution, sodium lauryl sulfate (SLS) was added to a final concentration of 0.00625%, 0.003125%, 0.00156%, 0.00078%, or 0.00039%. One mL of a 3.5×10⁶ CFU/ml culture of P. aeruginosa was then added to each silver citrate/surfactant test solution, and also to 700 mL SDIW as a control. The final concentration was ˜5000 CFU/ml in each 700 mL solution. The bottles were swirled to mix the bacteria into the solution and held for 10 minutes at ambient temperature. After 10 minutes, 10.0 ml were removed and transferred to 90 ml neutralizing recovery media in a French square bottle and mixed. The 1 ppm solution was assayed again after 30 minutes of exposure. Serial ten-fold dilutions were made as 1.0 ml into 9 ml PBS. One (1.0) ml portions of each dilution including the French square bottle were transferred to sterile petri plates and mixed with 25 ml molten nutrient agar (NA) (held at 45-50° C.). The contents of the French square bottle were then filtered through a sterile 0.45 μm membrane filter. The filter was rinsed with about 50 ml SDIW and transferred to NA in a petri plate. All plates were incubated for 24-48 hours at 35+2° C. Colonies were counted and multiplied by appropriate dilution factors to determine the number of surviving CFU of P. aeruginosa per ml of test solution. The results are tabulated in Table 4.

TABLE 4

| Test Solution | Orig. CFU/ml | CFU/ml | % Reduction |
|---|---|---|---|
| 1 tablet (Example 1) | 4286 | 2900 | 32% |
| 1 tablet + 0.00625% SLS | 4286 | 0.2 | 99.99% |
| 1 tablet + 0.003125% SLS | 4286 | 8.1 | 99.8% |
| 1 tablet + 0.00156% SLS | 9429 | 2730 | 71.0% |
| 1 tablet + 0.00078% SLS | 9429 | 5700 | 39.6% |
| 1 tablet + 0.00039% SLS | 9429 | 9200 | 2.4% |
| SDIW | 4286 | 4400 | 0% |

The results indicate that SLS concentrations of greater than 0.003125% increase the ability of silver citrate tablets dissolved in solution (at 1 ppm silver citrate) to reduce P. aeruginosa counts to less than 500 CFU/mL within 10 minutes. Hence, solid formulations comprising silver citrate and SLS that when dissolved yield solutions having 1 ppm silver citrate and >0.003125% SLS can effectively inhibit bacterial growth and biofilm formation in dental water units and dental water unit lines.

### Example 6

### Lyophilization of Silver Citrate

A silver citrate solution (2,374 ppm prepared according to the method described in U.S. Pat. No. 6,197,814) was lyophilized by:

1. Freezing the solution at −45° C. for 2 hours,

2. Bringing a vacuum over the frozen solution to 100 mT;

3. Ramping the temperature to −15° C. over 2.5 hours, then holding for 10 hours,

4. Ramping to 10° C. over 1 hour, then holding for 5 hours;

5. Ramping to 30° C. over 3 hours, holding for 72 hours, then adjusting the vacuum to 40 mT.

What is claimed is:

1. A solid composition comprising silver citrate at greater than about 4,000 parts per million.

2. The solid composition of claim 1 comprising silver citrate at between about 5,000 parts per million and about 11,000 parts per million.

3. The solid composition of claim 1 wherein said silver citrate is in the form of silver dihydrogen citrate (Ag₃C₆H₅O₇).

4. The solid composition of claim 1 wherein said silver citrate is in the form of the complex [Ag(HOOC—CH₂—C(OH)(COOH)—CH₂—COOH—H₂O)_{X}⁺(HOOC—CH₂—C(OH)(COOH)—CH₂—COO)⁻], wherein X is an integer.

5. The solid composition of claim 1 wherein said silver citrate is in the form of the complex [Ag⁺(HOOC—CH₂—C(OH)(COOH)—CH₂—COO)⁻].

6. The solid composition of claim 1 further comprising at least one surfactant.

7. The solid composition of claim 6 wherein said surfactant is selected from the group consisting of nonionic surfactants, cationic surfactants, anionic surfactants, zwitterionic surfactants, and amphoteric surfactants.

8. The solid composition of claim 6 wherein said surfactant is a quaternary ammonium surfactant.

9. The solid composition of claim 8 wherein said quaternary ammonium surfactant is selected from the group consisting of benzethonium chlorides and benzalkonium chlorides.

10. A tablet comprising the solid composition of claim 1 and optionally further comprising one or more binders, fillers or excipients.

11. A solid composition comprising silver dihydrogen citrate (Ag₃C₆H₅O₇).

12. The solid composition of claim 11 comprising silver dihydrogen citrate at between about 5,000 parts per million and about 11,000 parts per million.

13. The solid composition of claim 11 further comprising at least one surfactant.

14. The solid composition of claim 13 wherein said surfactant is selected from the group consisting of nonionic surfactants, cationic surfactants, anionic surfactants, zwitterionic surfactants and amphoteric surfactants.

15. The solid composition of claim 13 wherein said surfactant is a quaternary ammonium surfactant.

16. The solid composition of claim 15 wherein said quaternary ammonium surfactant is selected from the group consisting of benzethonium chlorides and benzalkonium chlorides.

17. A tablet comprising the solid composition of claim 11 and optionally further comprising one or more binders, fillers or excipients.

18. A method for inhibiting biofilm growth and maintenance in a dental unit water line connected to a dental unit water source, the method comprising:
adding a composition comprising silver citrate to said dental unit water source; and
introducing water from said dental unit water source into said dental unit water lines.

19. The method of claim 18 wherein said dental unit water source is a dental unit water reservoir.

20. The method of claim 18 wherein the final concentration of silver citrate in said dental unit water source is less than about 100 parts per million.

21. The method of claim 18 wherein the final concentration of silver citrate in said dental unit water source is less than about 10 parts per million.

22. The method of claim 18 wherein wherein the final concentration of silver citrate in said dental unit water source is between about 1 part per million and about 3 parts per million.

23. The method of claim 18 wherein said silver citrate is in the form of silver dihydrogen citrate (Ag₃C₆H₅O₇).

24. The method of claim 18 wherein said silver citrate is in the form of the complex [Ag(HOOC—CH₂—C(OH)(COOH)—CH₂—COOH—H₂O)_{X}⁺(HOOC—CH₂—C(OH)(COOH)—CH₂—COO)⁻], wherein X is an integer.

25. The method of claim 18 wherein said silver citrate is in the form of the complex: [Ag⁺(HOOC—CH₂—C(OH)(COOH)—CH₂—COO)⁻].

26. The method of claim 18 wherein said composition comprising silver citrate is added to said dental unit water source in solid form.

27. The method of claim 18 wherein said composition further comprises at least one surfactant.

28. The method of claim 27 wherein said surfactant is selected from the group consisting of nonionic surfactants, cationic surfactants, anionic surfactants, zwitterionic surfactants, and amphoteric surfactants.

29. The method of claim 27 wherein said surfactant is a quaternary ammonium surfactant.

30. The method of claim 29 wherein said quaternary ammonium surfactant is selected from the group consisting of benzethonium chlorides and benzalkonium chlorides.
